(19) United States
(12) Patent Application Publication
(10) Pub. No.: US 2010/0131873 A1
(43) Pub. Date: May 27, 2010

(54) CLINICAL FOCUS TOOL SYSTEMS AND METHODS OF USE

(75) Inventors: Carlos E. Mejia, Essex Junction, VT (US); Alexander Natanzon, Upper Saddle River, NJ (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/323,151

(22) Filed: Nov. 25, 2008

(51) Int. Cl. G06F 3/048

(52) U.S. Cl. 715/764

(57) ABSTRACT

Systems and methods provide integrated review and reporting of image studies including analog and/or digital images from one or more modalities/sources using clinical focus tools for both radiology and cardiology. An example clinical image viewer interface system includes an image viewer displaying analog and digital images from a plurality of modalities in a certain order. The image viewer includes a plurality of tools for review and reporting of an image study. The system also includes a tool library including a plurality of tools for image review, analysis, and reporting of an image study from multiple modalities and formats. Tools from the tool library are selectable to configure image review and reporting via the image viewer. The image viewer integrates reporting tools and reviewing tools from the tool library into a single interface for reviewing and reporting of analog and digital image studies across multiple modalities.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The presently described technology generally relates to image review and analysis. More specifically, the presently described technology relates to analog and digital image review and analysis using a single workflow interface.

Healthcare environments, such as hospitals or clinics, include information systems, such as hospital information systems (“HIS”), radiology information systems (“RIS), clinical information systems (“CIS”), and cardiovascular information systems (“CVIS”), and storage systems, such as picture archiving and communication systems (“PACS”), library information systems (“LIS”), and electronic medical records (“EMR”). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

PACS were initially used as an information infrastructure supporting storage, distribution, and diagnostic reading of images acquired in the course of medical examinations. As PACS developed and became capable of accommodating vast volumes of information and its secure access, PACS began to expand into the information-oriented business and professional areas of diagnostic and general healthcare enterprises. For various reasons, including but not limited to a natural tendency of having one information technology (IT) department, one server room, and one data archive/backup for all departments in healthcare enterprise, as well as one desktop workstation used for all business day activities of any healthcare professional, PACS is considered as a platform for growing into a general IT solution for the majority of IT oriented services of healthcare enterprises.

Medical imaging devices now produce diagnostic images in a digital representation. The digital representation typically includes a two dimensional raster of the image equipped with a header including collateral information with respect to the image itself, patient demographics, imaging technology, and other data used for proper presentation and diagnostic interpretation of the image. Often, diagnostic images are grouped in series each series representing images that have some commonality and differ in one or more details. For example, images representing anatomical cross-sections of a human body substantially normal to its vertical axis and differing by their position on that axis from top (head) to bottom (feet) are grouped in so-called axial series. A single medical exam, often referred as a “study” or an “exam” typically includes one or more series of images, such as images exposed before and after injection of contrast material or images with different orientation or differing by any other relevant circumstance(s) of imaging procedure. The digital images are forwarded to specialized archives equipped with proper means for safe storage, search, access, and distribution of the images and collateral information for successful diagnostic interpretation.

In prior systems, if a user wants to review both analog and digital images, the user must go to different workstations for different parts of the reading workflow. Further, a user may have to physically move to a separate reporting station to open a patient or study file, sign off on a report, and then go back to the previous station to continue what he or she was doing.

### BRIEF SUMMARY OF THE INVENTION

Certain embodiments of the present invention provide systems and methods for integrated review and reporting of image studies including analog and/or digital images from one or more modalities/sources using clinical focus tools for both radiology and cardiology.

Certain embodiments provide a clinical image viewer interface system providing integrated reviewing and reporting of image studies from multiple modalities. The system includes an image viewer displaying analog and digital images from a plurality of modalities in a certain order. The image viewer includes a plurality of tools for review and reporting of an image study. The system also includes a tool library including a plurality of tools for image review, analysis, and reporting of an image study from multiple modalities and formats. Tools from the tool library are selectable to configure image review and reporting via the image viewer. The image viewer integrates reporting tools and reviewing tools from the tool library into a single interface for reviewing and reporting of analog and digital image studies across multiple modalities.

Certain embodiments provide a method for providing clinical focus tools for clinical image review and reporting via a single interface accommodating analog and digital images from a plurality of modalities. The method includes retrieving an image study for a patient from one or more clinical sources. The image study includes images from one or more modalities in at least one of analog and digital format. The method also includes displaying the image study in a patient context with tools for integrated user review and reporting of multiple modality images. The method further includes generating a report based on user input provided via the tools.

Certain embodiments provide a machine readable medium having a set of instructions for execution on a computing device. The set of instructions, when executed on the computing device, cause the computing device to execute a method for providing clinical focus tools for clinical image review and reporting via a single interface accommodating analog and digital images from a plurality of modalities. The method includes retrieving an image study for a patient from one or more clinical sources. The image study includes images from one or more modalities in at least one of analog and digital format. The method also includes displaying the image study in a patient context with tools for integrated user review and reporting of multiple modality images. The method further includes generating a report based on user input provided via the tools.

### BRIEF DESCRIPTION OF SEVERAL VIEWS OF THE DRAWINGS

FIG. 1 demonstrates a business and application diagram for PACS information system in accordance with an embodiment of the present invention.

FIG. 2 illustrates an embodiment of an information system delivering application and business content in accordance with an embodiment of the present invention.

FIG. 3 illustrates a block diagram of an example clinical information system that may be used to implement systems and methods described herein.

FIG. 4 shows a block diagram of an example processor system that may be used to implement systems and methods described herein.

FIG. 5 illustrates an interface system for image viewing and manipulation in accordance with certain embodiments of the present invention.

FIG. 6 illustrates user selection options for cardiology viewer operation in accordance with certain embodiments of the present invention.

FIG. 7 shows an example layout editor allowing a user to edit various image type layouts in a single step configuration in accordance with certain embodiments of the present invention.

FIG. 8 illustrates an example of layout configuration for an image viewer in accordance with certain embodiments of the present invention.

FIG. 9 illustrates configuration of image thumbnail navigation in accordance with certain embodiments of the present invention.

FIG. 10 shows tools provided by an image viewer and tools library in accordance with certain embodiments of the present invention.

FIG. 11 shows example patient information and tool functionality provided to a user via an image viewer in accordance with certain embodiments of the present invention.

FIG. 12 illustrates a flow diagram for a method for providing clinical focus tools for radiology and cardiology image review in accordance with certain embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide integrated, synchronized access to digital and analog images from a variety of platforms (e.g., mammography, cardiology, radiology, etc.) via single workstation with a set of viewports. Various tools help to streamline a user's workflow in reviewing and reporting with respect to those images. Integration between workstations and tools provides an integrated reviewing and reporting interface for use with multiple modalities.

In prior systems, if a user wanted to review both analog and digital images, the user must go to different workstations for different parts of the reading workflow. Additionally, maintaining an order for the image slices including both analog and digital images is difficult. Further, a user may have to physically move to a separate reporting station to open a patient or study file, sign off on a report, and then go back to the previous station to continue what he or she was doing. Synchronization and other workflow facilitating capabilities are not present in these prior systems.

In certain embodiments, various tools are provided to facilitate exam reading and workflow in a variety of contexts. For example, mammography workflow tools include changing a display color scheme depending upon a workstep context (e.g., lights on, lights off on the folder, etc). Mammography workflow tools also provide an ability to have a digital workflow that emulates an analog workflow and goes through a stack of exams. Mammography imaging is undergoing a transition from an analog format to a digital format, and users will be reading both digital and analog mammography images for years as they make the switch from analog to digital. Sometimes users will digitize the analog images, and sometimes users will view digital images on one system and analog images on another system. Certain embodiments provide a solution that enables the reading of the analog and digital studies in the same order and in the same way as a physical or alternating stack of images. This solution helps support a dual workflow to read the exams in a certain order.

In certain embodiments, integration between reviewing/diagnostic station and reporting tools is facilitated. For example, an identifier for a patient or study is sent to a reporting station, and the patient or study file opens to a proper context. The reviewer can act and sign the report on the same station and then go back to what he or she was previously doing.

Mammography screening results are often negative. However, these results are often not simply “no” results but rather “no” with some characterization. A user may select an explanation to provide in conjunction with a “normal” result (such as selecting from a menu of possible options). Certain embodiments include an interface offering explanation selections and an ability to send to a reporting system all attributes of a normal mammography report so that a user can accomplish the workflow tasks using one interface application and sign the report so that the physician does not have to leave the context of his or her view.

In certain embodiments, a user interface provides multiple panes or viewports, where each viewport can display different information. However, the information may be related. Viewport synchronization can be provided through interface and workflow tools (e.g., window level and zoom synchronization across modalities), for example. For example, if there are different views of the same anatomical area (e.g., pre and post contrast) being displayed, and the user is zooming out on some area in one view, then the interface automatically zooms in the other open related view(s) as well. Zoom synchronization may not necessarily be one-to-one, but the image views are zoomed in such a way to expose essentially the same anatomical area, for example. All related views for an image series can be synchronized.

In certain embodiments, the user interface provides a mode of operation that indicates that a user wants to mimic an action taken in one viewport on the other related viewport(s), for example. The synchronization mode can be switched on or off. The synchronization mode can synchronize parameters/characteristics such as zoom, brightness, panning, etc. In one example, an application programming interface (“API”) is developed for a native viewport (e.g., a Voxar viewport) and a third party viewport so that if a diagnostic imaging product is embedded in the interface, there is a desired level of synchronization between view ports with respect to native and third party products. A patient context can also be synchronized, for example. Gray window level synchronization can also be facilitated. For example, if a user changes a window level in one image, all images of the same modality will correspondingly change.

In certain embodiments, tools are provided with an image viewer that can be used to show radiology, cardiology, and mammography images together in a single platform. A robust cardiology capability is provided to show multi-cines and cardiology tools along with a radiology PACS, for example. A third party application can be wrapped into the cardiology tools to show computer-aided detection (“CAD”) and echocardiogram (“ECG”) information as well. This provides a single platform solution rather than providing separate platforms for different functionalities/applications.

Cardiology tools can provide a single point of storage for all Digital Imaging and Communications in Medicine (“DICOM”) images including both radiology and cardiology. The tools can provide a single Web-based application or portal that can serve as a primary application for image and report review. The tools can provide capabilities to enable proper review of images and reports, according to current cardiology and/or radiology workflow standards. For example, certain embodiments provide an enhancement to cine display, thumbnail display, tools, etc. The tools can enable access to ECG data for review, for example. The tools can also offer distribution for cardiology reports from customer cardiovascular information systems (“CVIS”). Certain embodiments provide advanced analysis tools for catheterization and/or echocardiology, for example. Certain embodiments serve as a primary tool for analysis and reporting of cardiology and/or radiology procedures.

Certain embodiments relate to reading and interpretation of diagnostic imaging studies, stored in their digital representation and searched, retrieved, and read using a PACS and/or other clinical system. In certain embodiments, images can be stored on a centralized server while reading is performed from one or more remote workstations connected to the server via electronic information links. Certain embodiments help facilitate improved ergonomic screen layout, image manipulation, and image presentation for a diagnostic physician to provide more effective visual perception and diagnostic reading.

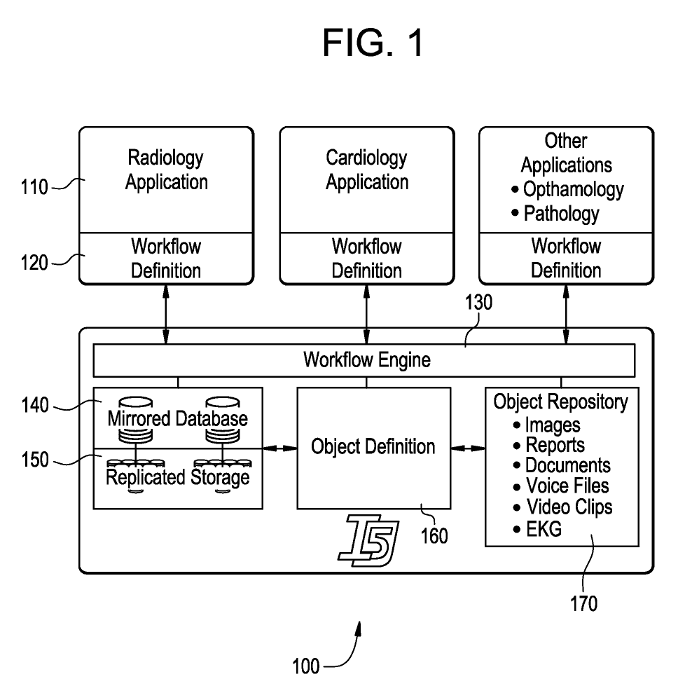

Certain embodiments provide an information system for a healthcare enterprise including a PACS system for radiology and/or other subspecialty system as demonstrated by the business and application diagram in FIG. 1. The system 100 of FIG. 1 includes a clinical application 110, such as a radiology, cardiology, ophthalmology, pathology, and/or application. The system 100 also includes a workflow definition 120 for each application 110. The workflow definitions 120 communicate with a workflow engine 130. The workflow engine 130 is in communication with a mirrored database 140, object definitions 60, and an object repository 170. The mirrored database 140 is in communication with a replicated storage 150. The object repository 170 includes data such as images, reports, documents, voice files, video clips, EKG information, etc.

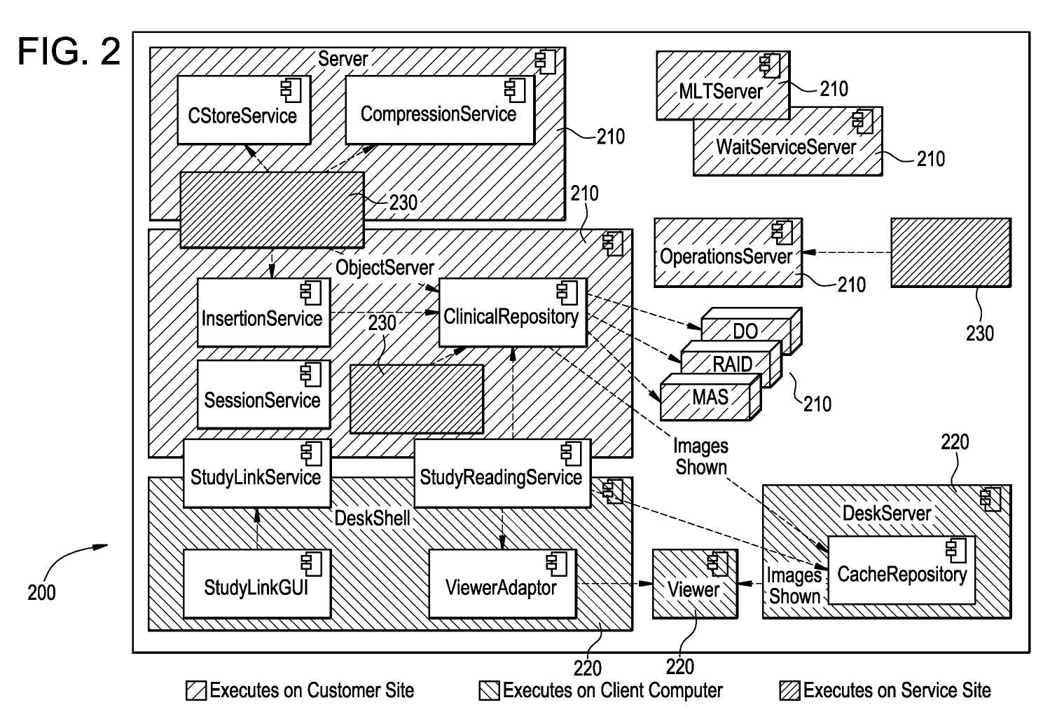

An embodiment of an information system that delivers application and business goals is presented in FIG. 2. The specific arrangement and contents of the assemblies constituting this embodiment bears sufficient novelty and constitute part of certain embodiments of the present invention. The information system 200 of FIG. 2 demonstrates services divided among a service site 230, a customer site 210, and a client computer 220. For example, a DICOM Server, HL7 Server, Web Services Server, Operations Server, database and other storage, an Object Server, and a Clinical Repository execute on a customer site 210. A Desk Shell, a Viewer, and a Desk Server execute on a client computer 220. A DICOM Controller, Compiler, and the like execute on a service site 230. Thus, operational and data workflow may be divided, and only a small display workload is placed on the client computer 220, for example.

Certain embodiments provide an architecture and framework for a variety of clinical applications. The framework can include front-end components including but not limited to a Graphical User Interface (“GUI”) and can be a thin client and/or thick client system to varying degree, which some or all applications and processing running on a client workstation, on a server, and/or running partially on a client workstation and partially on a server, for example.

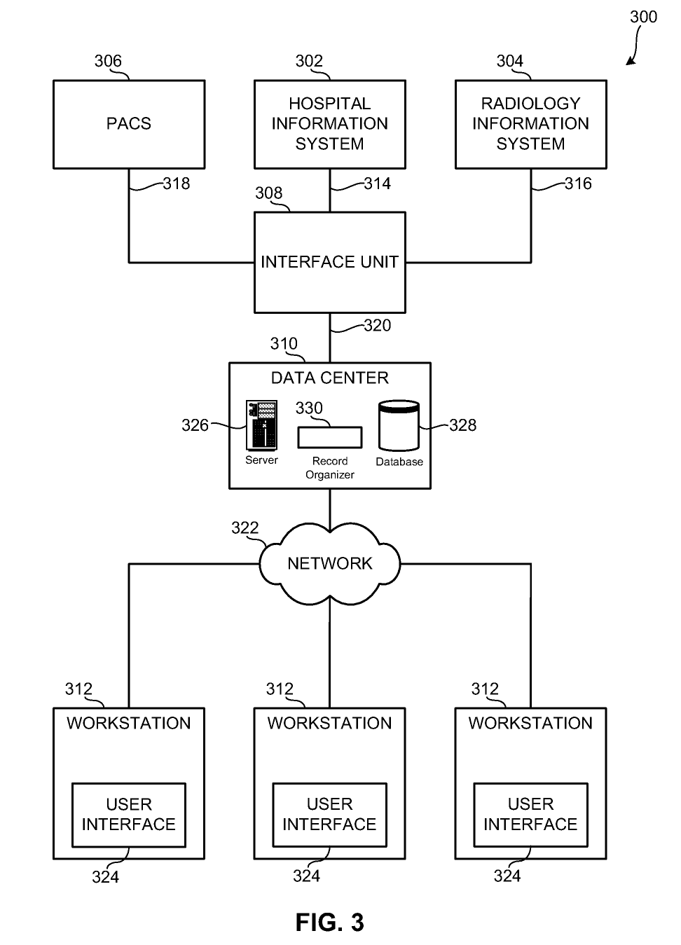

FIG. 3 shows a block diagram of an example clinical information system 300 capable of implementing the example methods and systems described herein. The example clinical information system 300 includes a hospital information system (“HIS”) 302, a radiology information system (“RIS”) 304, a picture archiving and communication system (“PACS”) 306, an interface unit 308, a data center 310, and a plurality of workstations 312. In the illustrated example, the HIS 302, the RIS 304, and the PACS 306 are housed in a healthcare facility and locally archived. However, in other implementations, the HIS 302, the RIS 304, and/or the PACS 306 may be housed one or more other suitable locations. In certain implementations, one or more of the PACS 306, RIS 304, HIS 302, etc., can be implemented remotely via a thin client and/or downloadable software solution. Furthermore, one or more components of the clinical information system 300 may be combined and/or implemented together. For example, the RIS 304 and/or the PACS 306 may be integrated with the HIS 302; the PACS 306 may be integrated with the RIS 304; and/or the three example information systems 302, 304, and/or 306 may be integrated together. In other example implementations, the clinical information system 300 includes a subset of the illustrated information systems 302, 304, and/or 306. For example, the clinical information system 300 may include only one or two of the HIS 302, the RIS 304, and/or the PACS 306. Preferably, information (e.g., scheduling, test results, observations, diagnosis, etc.) is entered into the HIS 302, the RIS 304, and/or the PACS 306 by healthcare practitioners (e.g., radiologists, physicians, and/or technicians) before and/or after patient examination.

The HIS 302 stores medical information such as clinical reports, patient information, and/or administrative information received from, for example, personnel at a hospital, clinic, and/or a physician's office. The RIS 304 stores information such as, for example, radiology reports, messages, warnings, alerts, patient scheduling information, patient demographic data, patient tracking information, and/or physician and patient status monitors. Additionally, the RIS 304 enables exam order entry (e.g., ordering an x-ray of a patient) and image and film tracking (e.g., tracking identities of one or more people that have checked out a film). In some examples, information in the RIS 304 is formatted according to the Health Level Seven (“HL-7”) clinical communication protocol.

The PACS 306 stores medical images (e.g., x-rays, scans, three-dimensional renderings, etc.) as, for example, digital images in a database or registry. In some examples, the medical images are stored in the PACS 306 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 306 for storage. In some examples, the PACS 306 may also include a display device and/or viewing workstation to enable a healthcare practitioner to communicate with the PACS 306.

The interface unit 308 includes a hospital information system interface connection 314, a radiology information system interface connection 316, a PACS interface connection 318, and a data center interface connection 320. The interface unit 308 facilities communication among the HIS 302, the RIS 304, the PACS 306, and/or the data center 310. The interface connections 314, 316, 318, and 320 may be implemented by, for example, a Wide Area Network (“WAN”) such as a private network or the Internet. Accordingly, the interface unit 308 includes one or more communication components such as, for example, an Ethernet device, an asynchronous transfer mode (“ATM”) device, an 802.11 device, a DSL modem, a cable modem, a cellular modem, etc. In turn, the data center 310 communicates with the plurality of workstations 312, via a network 322, implemented at a plurality of locations (e.g., a hospital, clinic, doctor's office, other medical office, or terminal, etc.). The network 322 is implemented by, for example, the Internet, an intranet, a private network, a wired or wireless Local Area Network, and/or a wired or wireless Wide Area Network. In some examples, the interface unit 308 also includes a broker (e.g., a Mitra Imaging's PACS Broker) to allow medical information and medical images to be transmitted together and stored together.

In operation, the interface unit 308 receives images, medical reports, administrative information, and/or other clinical information from the information systems 302, 304, 306 via the interface connections 314, 316, 318. If necessary (e.g., when different formats of the received information are incompatible), the interface unit 308 translates or reformats (e.g., into Structured Query Language (“SQL”) or standard text) the medical information, such as medical reports, to be properly stored at the data center 310. Preferably, the reformatted medical information may be transmitted using a transmission protocol to enable different medical information to share common identification elements, such as a patient name or social security number. Next, the interface unit 308 transmits the medical information to the data center 310 via the data center interface connection 320. Finally, medical information is stored in the data center 310 in, for example, the DICOM format, which enables medical images and corresponding medical information to be transmitted and stored together.

The medical information is later viewable and easily retrievable at one or more of the workstations 312 (e.g., by their common identification element, such as a patient name or record number). The workstations 312 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 312 receive commands and/or other input from a user via, for example, a keyboard, mouse, track ball, microphone, etc. As shown in FIG. 3, the workstations 312 are connected to the network 322 and, thus, can communicate with each other, the data center 310, and/or any other device coupled to the network 322. The workstations 312 are capable of implementing a user interface 324 to enable a healthcare practitioner to interact with the clinical information system 300. For example, in response to a request from a physician, the user interface 324 presents a patient medical history. Additionally, the user interface 324 includes one or more options related to the example methods and apparatus described herein to organize such a medical history using classification and severity parameters.

The example data center 310 of FIG. 3 is an archive to store information such as, for example, images, data, medical reports, and/or, more generally, patient medical records. In addition, the data center 310 may also serve as a central conduit to information located at other sources such as, for example, local archives, hospital information systems/radiology information systems (e.g., the HIS 302 and/or the RIS 304), or medical imaging/storage systems (e.g., the PACS 306 and/or connected imaging modalities). That is, the data center 310 may store links or indicators (e.g., identification numbers, patient names, or record numbers) to information. In the illustrated example, the data center 310 is managed by an application server provider (“ASP”) and is located in a centralized location that may be accessed by a plurality of systems and facilities (e.g., hospitals, clinics, doctor's offices, other medical offices, and/or terminals). In some examples, the data center 310 may be spatially distant from the HIS 302, the RIS 304, and/or the PACS 306 (e.g., at General Electric® headquarters).

The example data center 310 of FIG. 3 includes a server 326, a database 328, and a record organizer 330. The server 326 receives, processes, and conveys information to and from the components of the clinical information system 300. The database 328 stores the medical information described herein and provides access thereto. The example record organizer 330 of FIG. 3 manages patient medical histories, for example. The record organizer 330 can also assist in procedure scheduling, for example.

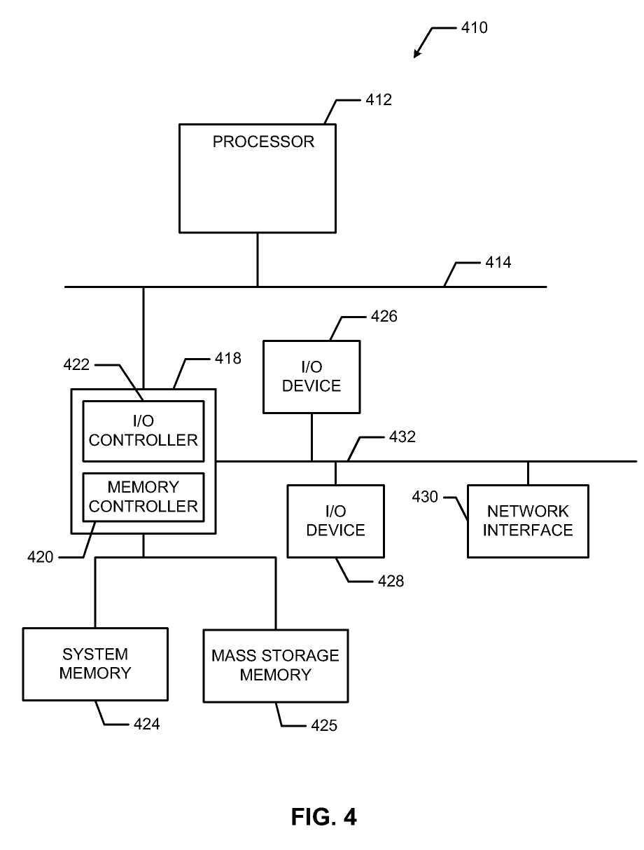

FIG. 4 is a block diagram of an example processor system 410 that may be used to implement systems and methods described herein. As shown in FIG. 4, the processor system 410 includes a processor 412 that is coupled to an interconnection bus 414. The processor 412 may be any suitable processor, processing unit, or microprocessor, for example. Although not shown in FIG. 4, the system 410 may be a multi-processor system and, thus, may include one or more additional processors that are identical or similar to the processor 412 and that are communicatively coupled to the interconnection bus 414.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 may include any desired type of volatile and/or non-volatile memory such as, for example, static random access memory (“SRAM”), dynamic random access memory (“DRAM”), flash memory, read-only memory (“ROM”), etc. The mass storage memory 425 may include any desired type of mass storage device including hard disk drives, optical drives, tape storage devices, etc.

The I/O controller 422 performs functions that enable the processor 412 to communicate with peripheral input/output (I/O) devices 426 and 428 and a network interface 430 via an I/O bus 432. The I/O devices 426 and 428 may be any desired type of I/O device such as, for example, a keyboard, a video display or monitor, a mouse, etc. The network interface 430 may be, for example, an Ethernet device, an asynchronous transfer mode (“ATM”) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks may be integrated within a single semiconductor circuit or may be implemented using two or more separate integrated circuits.

According to certain embodiments considered as examples in the present application, media files imported from a medical imaging device into a PACS are optionally subjected to a layered incremental compression. Certain media files are grouped in sequences called series, and certain series are grouped into studies, where each study represents a total set of media associated with a single medical exam. Each such study can be optionally attributed to a study type, where each study type is associated with a certain protocol for study interpretation. The protocol can include but is not limited to an order and positions for series display, configuration of a toolbar, annotation and measuring tools, and/or other data required for more efficient presentation of diagnostic images and rendering of a diagnosis. The set of tools and resources is referred to as a “study layout.”

For each study registered in the database, an algorithm (e.g., a unique algorithm) exists for creation of a list of respective series and individual images included in the study and selection of a proper layout for study display. Upon getting a request for study display, the server first generates comprehensive lists of media files to be used for reading the study and a related layout for study display. These lists are transferred to a client workstation and copies are kept on the server. According to the generated list of media files and a chosen layout for their presentation on the client workstation, a plan for transferring and optional processing and/or decompression of the media files is built and coordinated between client and server.

According to that plan, a first batch of media transfer includes a minimum amount of compression layers to deliver a coarse enough representation of the image(s) provided such that the coarse representation, while not suitable for diagnostic reading, is sufficient for navigating between the images to review the whole study and then focus on images with high diagnostic value. Upon presentation of the images on the diagnostic or other workstation, tools are offered to an operator for implementation of a diagnostic workflow or other relevant workflow. For example, tools can include but are not limited to: scrolling through the stack of images, adjusting brightness/contrast of the images, making measurements and annotations of the images, rendering some other representation(s) such as three-dimensional (“3D”) or oblique slicing, dictation and reporting tools, and/or other relevant tools.

A variety of image display and manipulation tools and other functionality can be provided by the PACS framework described above. The following description details several examples for purposes of illustration only.

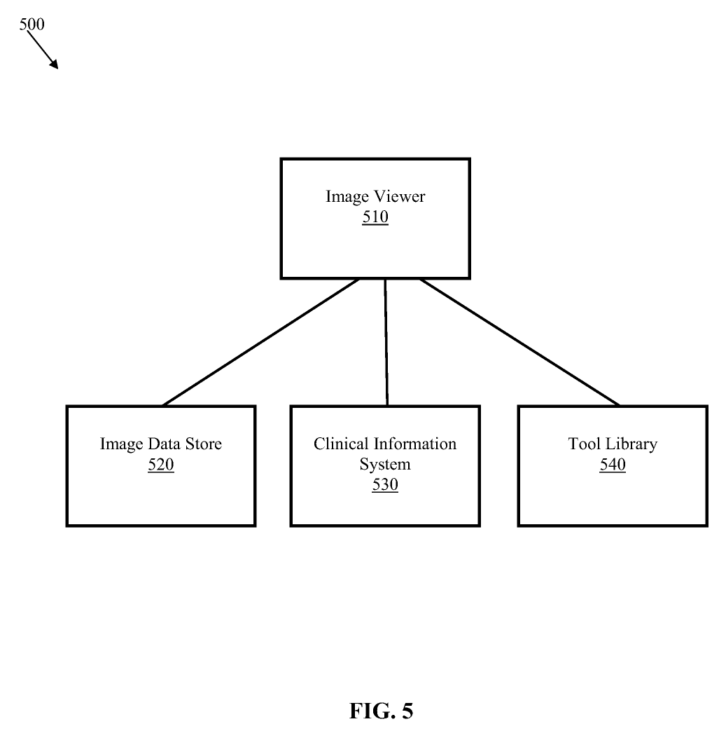

Certain embodiments provide a display and support framework for cardiology, radiology, and mammography imaging, analysis, and reporting, for example. FIG. 5 illustrates an interface system 500 for image viewing and manipulation in accordance with certain embodiments of the present invention. The system 500 includes an image viewer 510, an image data store 520, one or more clinical information systems 530, and a tool library 540. The components of the system 500 can be implemented alone or in various combinations of hardware, software, and/or firmware, for example.

The image viewer 510 provides image content to a user from the image data store 520 and/or one or more clinical information systems 530. The image data store 520 can be a part of one or more clinical information systems 530 and/or can be a separate image archive, for example. The image viewer 510 also provides one or more tools from the tool library 540 to facilitate user review, manipulation, annotation, reporting, etc., with respect to displayed image data on the viewer 510, for example.

The image viewer 510 can provide cardiology support via one or more connections to clinical information systems 530 such as cardiac catheterization lab, echocardiology, cardiac nuclear medicine, and/or cardiac CT modality systems. Additionally, the image viewer 510 can provide a radiology centric view. Via the image viewer 510, images can be reviewed by a user, such as a cardiologist or radiologist, and can be stored in the image data store 520, such as a PACS archives The viewer 510 can provide diagnostic quality display of cardiac images, etc., and can facilitate distribution of cardiac images inside and outside a clinical environment, such as a hospital, for a referring physician. The image viewer 510 can also provide a single cine view of image data, for example. Tools from the tool library 540 can include standard imaging tools for measurement, magnification, image enhancement, contrast/brightness adjustment, etc.

In a cardiology-focused view, the image viewer 510 can provide enhanced cine capabilities (e.g., next cine, previous cine, etc.). Multi-cine display can be supported (e.g., up to eight cines at thirty frames per second), for example. The tool library 540 can provide productivity tools for display of catheterization and echocardiology images. The image viewer 510 can display cardiovascular imaging system reports from a cardiology reporting system 530, such as GE's Centricity DMS (Data management System) Cardiology reporting system. The viewer 510 can display EKG data as well.

In certain embodiments, the image data store 520 provides a single database solution for storage of image and/or other clinical data. The image data store 520 can also be divided into multiple interconnected databases and/or can be integrated with one or more clinical systems 530, such as imaging modalities, PACS, etc.

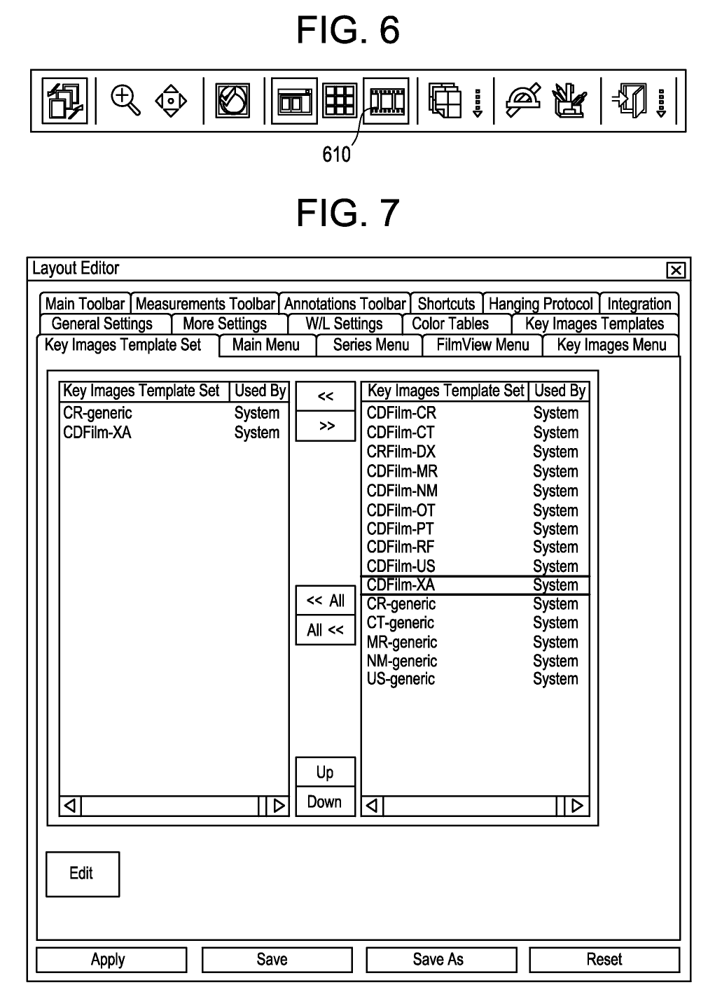

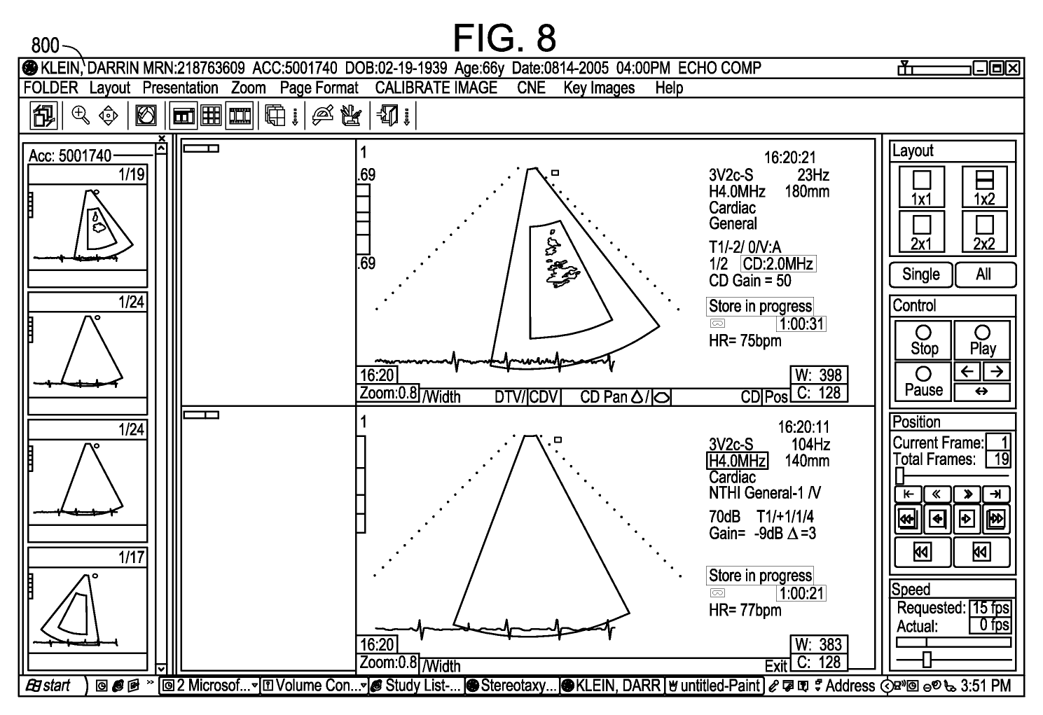

Certain embodiments provide a configurable image viewer 510 providing a user with a plurality of configuration options/parameters for image viewing and analysis. As illustrated in FIG. 6, for example, a user can select an option 610 to run a cardiology viewer for catheterization and echocardiology exams. FIG. 7 shows an example layout editor allowing a user to edit various image type layouts in a single step configuration. The user can apply the same configuration to other exams as well. As illustrated in FIG. 8, for example, the viewer 510 can be configured with a layout 800 including cine-focused controls, various speed settings, thumbnail image views, etc.

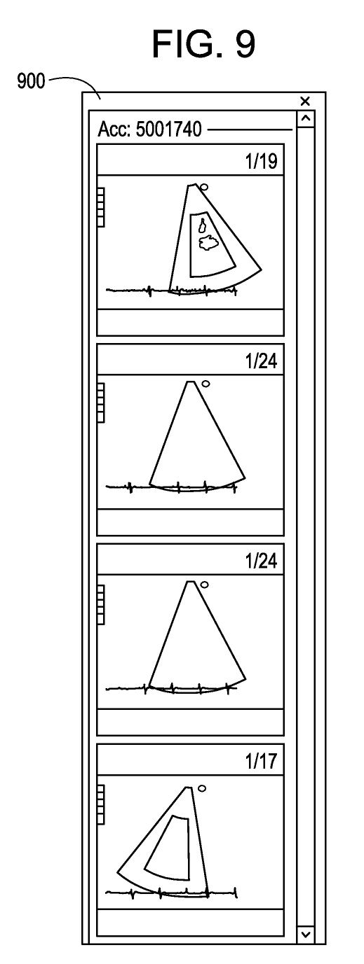

As illustrated in FIG. 9, navigation through an image stack or series of image thumbnails and/or full images 900 can be configured by the user. The viewer 510 provides a display of image series and image count information. Content displayed on the viewer 510 can be expandable, including a scroll bar to show previously hidden (e.g., off the screen) information, for example. The viewer 510 can be configured to show multiple exams from one or more modalities.

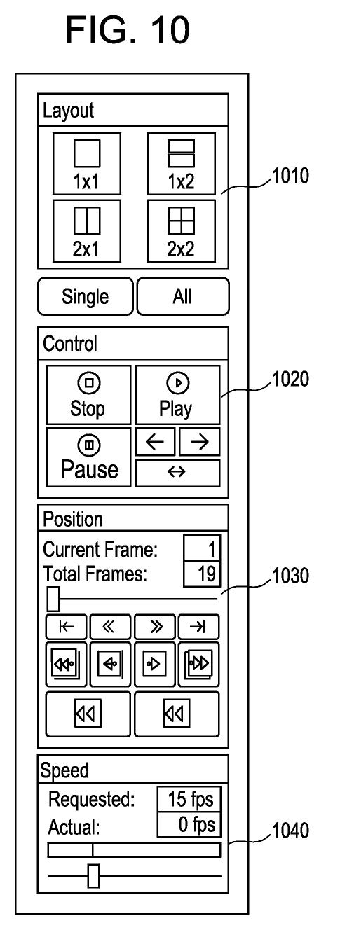

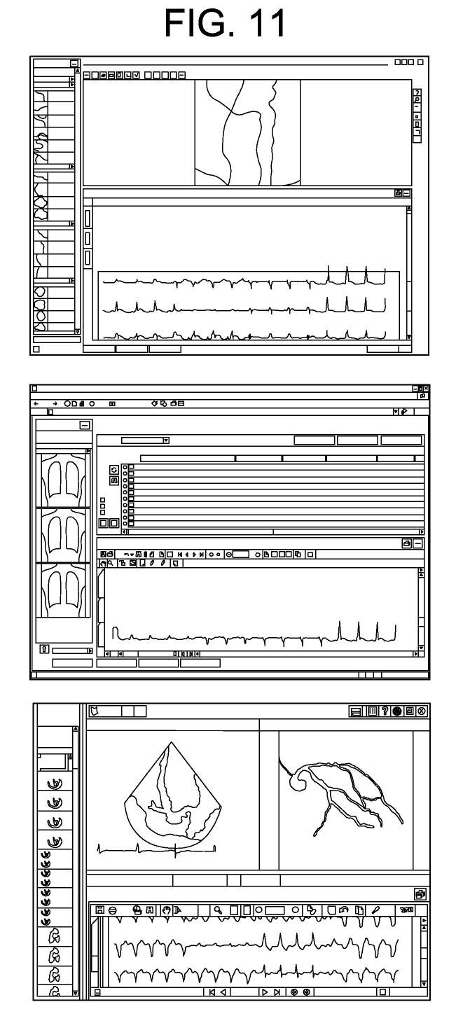

As shown, for example, in FIG. 10, the image viewer 510 and tools library 540 provide cardiology focused tools, such as layout tools. A layout grid 1010, such as a 1×1, 1×2, 2×1, and 2×2 can be selected for application, for example. Control options 1020 provide options such as play, stop, pause, scroll to end and start, scroll back and forth, etc. Position options 1030 provide options such as frame number display, total frame display, next/previous frame, next/previous cine, etc. Speed settings 1040 provide options including support for up to sixty frames per second, default to acquired speed, progress/manual speed control bar, etc. As shown in FIG. 11, a variety of patient information and tool functionality can be provided to the user via the image viewer 510 in conjunction with the tool library 540, image data store 520, clinical information system 530, etc.

Various analysis packages, such as a cardiac (e.g., QCA/LVA) analysis package, a clinical analysis package (e.g., echocardiology), cardiac CT, cardiac NM, etc., can be provided via the tools library 540. The tools library 540 can also include a reporting component accessible via the image viewer 510. For example, with cardiac CT, image and full structured reporting can be provided to a user via the image viewer 510. Nuclear medicine, electrophysiology, and/or vascular structured reporting can be provided, for example. DICOM ECG storage, support, and/or diagnosis can also be facilitated via the image viewer 510, tools library 540, etc. The system 500 can be integrated with a CVIS and/or other clinical system 520, for example, to provide resource management and access to clinical data (e.g., pre and/or post procedure).

Additionally, in certain embodiments, rather than clicking on or otherwise selecting a tool bar to change a mouse mode of the image viewer 510 (e.g., scrolling, zooming, etc.), the user can maneuver the cursor to the proper area of an image display overlay (e.g., lower left for zoom/scroll of image, upper left to scroll through image series, bottom right to change contrast, etc.) to facilitate a change in mouse mode. Further, field of view synchronization can be provided. For example, if a user zooms in one image, other derivative/corresponding image(s) are zoomed accordingly, panned accordingly, etc. In certain embodiments, zooming among the images is not necessarily a one-to-one correspondence, but related images can be zoomed in such a way as to expose essentially the same anatomical area in all affected images. All related views for that particular series can be synchronized, for example. Similar techniques can be applied to gray window level synchronization, for example. If a user changes window level in one viewed image, all images of the same modality can correspondingly change.

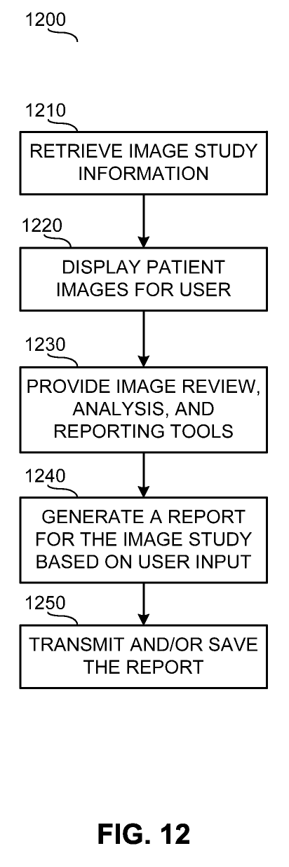

FIG. 12 illustrates a flow diagram for a method 1200 for providing clinical focus tools for radiology and cardiology image review in accordance with certain embodiments of the present invention. At 1210, image study information for a patient is retrieved from one or more clinical sources for display. At 1220, patient study images are displayed via an image viewer for user review and reporting. At 1230, tools are provided to the user for image review, analysis, and reporting. At 1240, a report is generated based on user input. At 1250, the report is transmitted and/or saved.

For example, at 1210, images from one or more modalities obtained and/or stored at one or more clinical systems (e.g., a PACS, a CVIS, an x-ray machine, etc.) can be retrieved to a single access point, such as an image viewer. Both analog and digital images can be retrieved and organized for display, for example. Images can include additional patient information such as CAD, ECG, etc. At 1220, using the image viewer, the images are displayed for user review at a workstation, such as a PACS workstation. The images can be displayed in a particular order and/or patient context, for example. Images can be displayed in multiple viewports of the image viewer, for example. The multiple viewports can be synchronized such that a change in one viewport (e.g., a zoom, a window level adjustment, etc.) is replicated (at least substantially, given certain image and/or viewing constraints) in one or more related viewports, for example. At 1230, tools, such as cardiology, radiology, mammography, and/or general image review/analysis tools, are provided to the user in conjunction with the image viewer (e.g., the image viewer 510 of FIG. 5). Tools can include cine, multi-cine, thumbnail display, image view manipulation (e.g., scroll, zoom, window level, contrast, etc.), structured reporting, cardiac/ECG review, cross-modality tools, advanced analysis tools, etc. Third party and native applications and tools can both be supported on the image viewing platform, for example. At 1240, a report is generated based on user input. The report can be a structured report generated using a tool and image and/or other displayed patient data, for example. At 1250, the report is transmitted and/or saved. Image annotation and/or other information can be saved as well. The report and/or other information can be transmitted to a clinical information system, a clinician for review/consultation, a billing system, etc. The report and/or other information can be saved to a clinical information system, image data store, archive, electronic medical record, and/or other clinical source, for example.

One or more of the steps of the method 1200 may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device.

Certain examples may omit one or more of these steps and/or perform the steps in a different order than the order listed. For example, some steps may not be performed in certain examples. As a further example, certain steps may be performed in a different temporal order, including simultaneously, than listed above.

Thus, certain embodiments provide systems and methods for display of both analog and digital images in a reading order from one or more modalities/sources. Certain embodiments provide synchronization and workflow facilitating capabilities to streamline and enhance user review and reporting in a reading workflow. Certain embodiments provide a Web-based interface for such a reading workflow. Certain embodiments provide integrated, synchronized access to digital and analog images from a variety of platforms (e.g., mammography, cardiology, radiology, etc.) via single workstation with a set of viewports. Various tools help to streamline a user's workflow in reviewing and reporting with respect to those images.

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A clinical image viewer interface system providing integrated reviewing and reporting of image studies from multiple modalities, said system comprising:
an image viewer displaying analog and digital images from a plurality of modalities in a certain order, the image viewer including a plurality of tools for review and reporting of an image study; and
a tool library including a plurality of tools for image review, analysis, and reporting of an image study from multiple modalities and formats, tools from the tool library selectable to configure image review and reporting via the image viewer,
wherein the image viewer integrates reporting tools and reviewing tools from the tool library into a single interface for reviewing and reporting of analog and digital image studies across multiple modalities.

2. The system of claim 1, wherein the image viewer comprises a plurality of viewports, each viewport including an image from the image study.

3. The system of claim 2, wherein the viewports are synchronized such that a change in an image in one viewport produces a corresponding change in another viewport.

4. The system of claim 3, wherein a change comprises at least one of a zoom and a window level adjustment.

5. The system of claim 1, wherein the image viewer displays analog and digital images from a plurality of modalities in a particular patient context.

6. The system of claim 1, wherein the image viewer and associated tools allow a user to move through the images like an image stack including both analog and digital images.

7. The system of claim 6, wherein moving through the images comprises at least one of scrolling, cine, and multi-cine through the images.

8. The system of claim 1, wherein the image viewer facilitates structured reporting of an image study using tools from the tool library.

9. The system of claim 1, wherein the image viewer includes native and third party applications synchronized for operation on displayed images.

10. The system of claim 1, wherein the tool library includes cardiology and radiology tools.

11. A method for providing clinical focus tools for clinical image review and reporting via a single interface accommodating analog and digital images from a plurality of modalities, said method comprising:
retrieving an image study for a patient from one or more clinical sources, the image study including images from one or more modalities in at least one of analog and digital format;
displaying the image study in a patient context with tools for integrated user review and reporting of multiple modality images; and
generating a report based on user input provided via the tools.

12. The method of claim 11, wherein the image study is displayed via a plurality of viewports in an image viewer, each viewport including an image from the image study.

13. The method of claim 12, wherein the viewports are synchronized such that a change in an image in one viewport produces a corresponding change in another viewport.

14. The method of claim 13, wherein a change comprises at least one of a zoom and a window level adjustment.

15. The method of claim 11, further comprising moving through display of images in the image study like an image stack including both analog and digital images.

16. The method of claim 15, wherein moving through the images comprises at least one of scrolling, cine, and multi-cine through the images.

17. The method of claim 11, wherein generating a report further comprises facilitating structured reporting of an image study using reporting tools provided to a user via an image viewer.

18. The method of claim 11, further comprising synchronizing native and third party applications for operation on displayed images from the image study.

19. The method of claim 11, wherein both cardiology and radiology tools are provided with the image study for use by a user.

20. A machine readable medium having a set of instructions for execution on a computing device, the set of instructions, when executed on the computing device, causing the computing device to execute a method for providing clinical focus tools for clinical image review and reporting via a single interface accommodating analog and digital images from a plurality of modalities, said method comprising:
retrieving an image study for a patient from one or more clinical sources, the image study including images from one or more modalities in at least one of analog and digital format;
displaying the image study in a patient context with tools for integrated user review and reporting of multiple modality images; and
generating a report based on user input provided via the tools.
